(19) United States
(12) Patent Application Publication
(10) Pub. No.: US 2008/0294532 A1
(43) Pub. Date: Nov. 27, 2008

(54) SYSTEM AND METHOD FOR ON-LINE AUTOMOBILE TRADING

(75) Inventor: Daniel W. Osborne, Lititz, PA (US)

Correspondence Address: DUANE MORRIS LLP - Philadelphia;IP DEPARTMENT, 30 SOUTH 17TH STREET, PHILADELPHIA, PA, 19103-4196, US

(73) Assignee: CARTANGO, INC., LITITZ, PA (US)

(21) Appl. No.: 12/124,841

(22) Filed: May 21, 2008

Related U.S. Application Data
(60) Provisional application No. 60/939,127, filed on May 21, 2007.

(51) Int. Cl. G06Q 30/00

(52) U.S. Cl. 705/26

(57) ABSTRACT

A method of trading automobiles, having the steps of entering a preferred set of attributes for a purchase of an automobile, creating a personalized shopping page based on the preferred set of attributes, searching a database of automobiles satisfying the preferred set of attributes, and displaying automobiles from the database that satisfy the preferred set of attributes.

### CROSS-REFERENCE TO RELATED APPLICATIONS

This is a United States non-provisional application of U.S. provisional patent application Ser. No. 60/939,127, filed May 21, 2007, by Daniel W. Osborne, the entirety of which application is incorporated herein by reference.

### COPYRIGHT CLAIM

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention generally relates to on-line trading of property, and more particularly, to a system for on-line trading of automobiles.

### BACKGROUND OF THE INVENTION

The buying and selling of products and services has resulted in a vast array of buying schemes that are used to vary the price at which such products are sold. A common buying method, which businesses encounter regularly, is known as volume buying. According to this buying method, sellers set a fixed unit price for their products based on the volume of units that a buyer is willing to purchase. Buyers desiring to purchase products from the seller are each required to pay the same fixed price depending on the volume of units the buyer is purchasing. If a seller finds that the demand for a given product is greater or less than expected, the seller may later adjust the fixed price per unit of the product to account for such findings. Although the fixed price per unit system provides a simple way for a seller to conduct business with multiple buyers, one drawback of this buying method is that it fails to provide buyers with a choice between a variety of different buying criteria that may be just as important as or more important to the buyer than price.

For example, a buyer that is in need of goods, such as raw materials to make products for an expedited order, may be willing to pay a higher price for a faster delivery time. Another buyer may be concerned with the quality of the goods they are purchasing, such that the buyer would pay a higher price for goods having a minimum number of defects. Yet another buyer may be concerned with the warranty time allotted for the goods they are purchasing, and may want the warranty of the goods that they are purchasing to match or exceed the warranty the buyers are offering their own customers.

Yet another buying method which has been advanced in recent years is buyer-driven bidding. According to this buying method, a single buyer desiring to obtain a product communicates a price at which the buyer is willing to purchase the product to multiple sellers. Each of the sellers is provided an opportunity to review the buyer's price. A sale is complete when one of the sellers agrees to sell the product to the buyer at the price suggested by the buyer. While the buyer-driven bidding method provides advantages for certain types of transactions when, for example, sellers may be willing to sell products at lower than normal prices, the uncertainties involved with whether a buyer's offer will be accepted is often problematic for high volume commercial transactions in which the reliability that a transaction will be complete is of paramount importance. Another problem with the present buying methods is that the buyers have no control in determining the criteria of the product or services that they may receive, while the seller has no control of the type of purchase that the buyer's request.

Online shopping has become a preferred way to obtain consumer products, such as automobiles. Consumers often use the Internet to browse, comparison shop, and order products on-line. Online shopping systems have made product information, including pricing and availability, readily available to consumers and have facilitated the location and purchasing of desired products at lower costs. The current on-line shopping alternatives do not maximize the shopping experience for buyers or sellers.

### SUMMARY OF THE INVENTION

In one example embodiment, a method of trading automobiles is provided, the method comprising entering a preferred set of attributes for a purchase of an automobile, creating a personalized shopping page based on the preferred set of attributes, searching a database of automobiles satisfying the preferred set of attributes and displaying automobiles from the database that satisfy the preferred set of attributes.

In another embodiment, the displaying of the automobiles from the database that satisfy the preferred set of attributes includes at least one of presenting an automobile seller profile and providing an automobile seller profile inventory list.

In another embodiment, the personalized shopping page has at least one of a favorites list, a message list, a presentation of search results list, a search parameters list and a buyer profile.

In another embodiment, the method further comprises initiating the trading of automobiles by entering and verifying a user through a log-in portal. In another embodiment, the method further comprises completing an initial registration for a user prior to the initiating the trading of the automobile by entering and verifying the user.

In yet another embodiment, the method further comprises providing a message list allowing a buyer and a seller of an automobile to communicate. In another embodiment, the mode of communication is email.

In another embodiment, the method further comprises listing a best deal on at least one class of automobiles prior to the creation of the personalized shopping page.

In another embodiment, the method further comprises creating the database of automobiles by obtaining inventory lists from a seller using a seller module.

In another embodiment, the seller module provides at least one of providing a contact method between a buyer and a seller, providing a seller profile to at least one of a buyer and a seller database, providing a search presentation for advertising of the seller, and providing an on-line chat capability between a buyer and a seller.

In another embodiment, the method further comprises conducting a log-in for the seller module.

In yet another embodiment, the method further comprises providing recent activity results of searches performed by potential buyers to sellers.

In another embodiment, the seller module is one of a commercial seller and a private party seller.

In another embodiment, a program storage device readable by machine, tangibly embodying a program of instructions executable by machine to perform method steps to trade an automobile is presented. The method performed comprises entering a preferred set of attributes for a purchase of an automobile, creating a personalized shopping page based on the preferred set of attributes, searching a database of automobiles satisfying the preferred set of attributes, and displaying automobiles from the database that satisfy the preferred set of attributes.

In another embodiment, the program storage device is presented, wherein the displaying of the automobiles from the database that satisfy the preferred set of attributes includes at least one of presenting an automobile seller profile and providing an automobile seller profile inventory list.

In another embodiment, the program storage device is provided wherein the personalized shopping page has at least one of a favorites list, a message list, a presentation of search results list, a search parameters list and a buyer profile.

In another embodiment, the program storage device is provided wherein the method accomplished further comprises initiating the trading of automobiles by entering and verifying a user through a log-in portal.

In another embodiment, the program storage device is presented wherein the method accomplished further comprises completing an initial registration for a user prior to the initiating the trading of the automobile by entering and verifying the user.

In another embodiment, the program storage device is presented wherein the method accomplished further comprises providing a message list allowing a buyer and a seller of an automobile to communicate.

In another embodiment, the program storage device is presented such that a mode of communication is email.

In another embodiment, the program storage device may further be configured such that the method performed further includes listing a best deal on at least one class of automobiles prior to the creation of the personalized shopping page.

In another embodiment, the program storage device may be further configured such that the method performed further includes creating the database of automobiles by obtaining inventory lists from a seller using a seller module.

In another embodiment, the program storage device may further be configured such that the method performed further includes at least one of providing a contact method between a buyer and a seller, providing a seller profile to at least one of a buyer and a seller database, providing a search presentation for advertising of the seller, and providing an on-line chat capability between a buyer and a seller.

In another embodiment, the program storage device may further be configured such that the method performed further includes conducting a log-in for the seller module.

In another embodiment, the program storage device may further be configured such that the method performed further includes providing recent activity results of searches performed by potential buyers to sellers.

In another embodiment, the program storage device may further be configured such that the seller module is one of a commercial seller and a private party seller. In another embodiment, the method may further comprise completing an on-line questionnaire to determine an appropriate automobile choice for a consumer; and displaying the automobile choice to an individual.

In another embodiment, the method is performed such that in the creating the personalized shopping page based on the preferred set of attributes, at least two sellers compete in advertising of automobiles

In a still further embodiment, the method may further comprise searching the database of automobiles satisfying the preferred set of attributes at a defined interval and displaying results of the search to an individual.

### BRIEF DESCRIPTION OF THE DRAWINGS

These and other features and advantages of the present invention will be more fully disclosed in, or rendered obvious by, the following detailed description, which is to be considered together with the accompanying drawings wherein like numbers refer to like parts and further wherein:

FIG. 1 is a flowchart of a buyer module of the system in accordance with an embodiment of the invention.

FIG. 2 is a flowchart of a seller module of the system in accordance with an embodiment of the invention.

FIG. 3 is a flowchart of a private party seller module of the system in accordance with an embodiment of the invention.

FIG. 4 is an summary flowchart of the system in accordance with an embodiment of the invention.

### DETAILED DESCRIPTION

This description of example embodiments is intended to be read in connection with the accompanying drawings, which are to be considered part of the entire written description of this invention. In the claims, means-plus-function clauses, if used, are intended to cover the structures described, suggested, or rendered obvious by the written description or drawings for performing the recited function, including not only structural equivalents but also equivalent structures. Although described as relating on-line automobile trading, the application is applicable to commerce, such as purchase and advertising of automobiles.

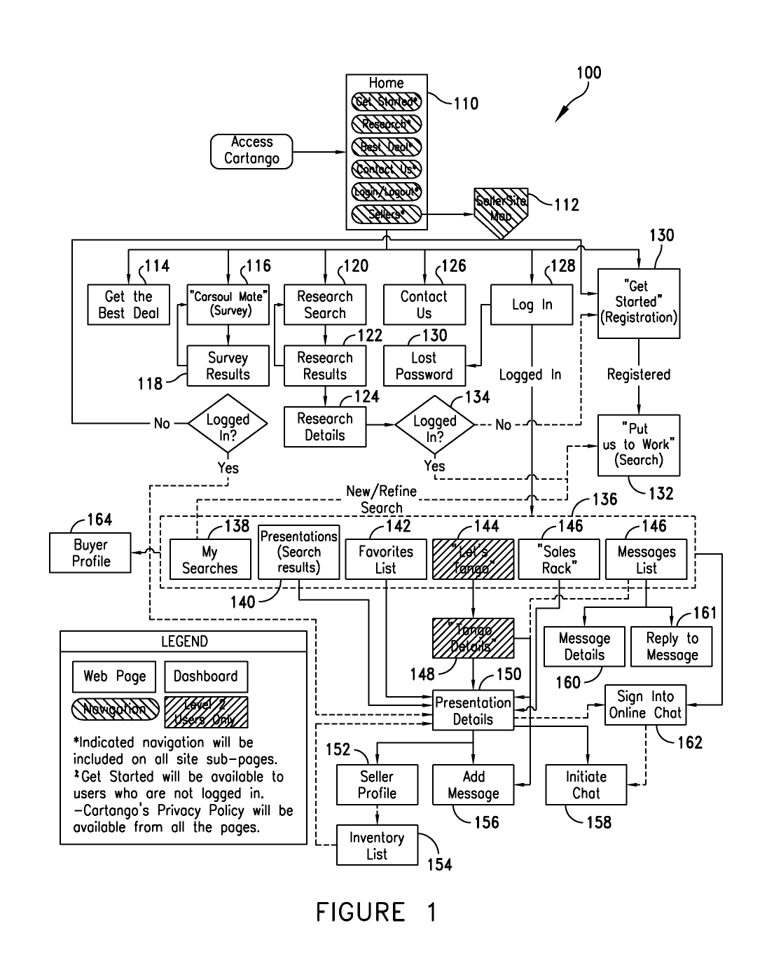

Referring to FIG. 1, a system and method for on-line automobile trading is provided in which automobile buyers and sellers are aggregated so as to facilitate their interaction with one another to provide a unique and meaningful experience. Through site registration, buyers gain access to a “Personalized Shopping” page 136. The site searches for vehicles that match a user's defined search criteria. As buyers narrow their search, they will be able to add vehicles to a forum where buyers invite sellers to compete directly for their business, and sellers have visibility of competing presentations made by other sellers. This area is designated as a “Let's Tango” area 144 of the “Personalized Shopping” page 136. When vehicles are entered into the “Tango”, the lines of communication are opened to sellers, who can compete and modify their vehicle presentations 140. In some embodiments, access to industry research is provided, along with a messaging list 146 that will allow message details 160 to be determined, as well as reply to messages 161. A chat section is also provided, wherein uses may sign into an online chat 162 and initiate/participate in a chat 158.

In one embodiment, a system and method for on-line automobile trading formed and operated in accordance with the present invention includes a buyer module 100, a seller module 200, and an administrator module 444, 446, 448. Buyer module 100 provides an external facing site, available to the public. Seller module 200 is accessible to subscribing sellers; including, but not limited to dealerships and private party sellers. Administrator module is for internal users and will provide necessary administrative functions to manage sellers, buyers and advertisers. The foregoing modules may be implemented in various software, for example, using Microsoft® NET 2.0 and Microsoft® SQL Server 2005.

System and method for on-line automobile trading is targeted to potential automobile buyers, with a limited set of features offered to anonymous users, and a more robust feature set provided once users have registered. Registration helps to further qualify potential leads for subscribing sellers. In one embodiment, a level one registration is directed to basic users, requiring only a minimal amount of information, where as a level two registration provides a buyer with additional contact information, which be shared with sellers as their level of commitment towards a vehicle purchase or dealer relationship increases. Only buyers in the second level will be able to participate in the site's “Let's Tango” feature, in which buyers invite sellers to compete directly for the buyer's business.

### User Registration

When potential buyers initially visit the site, they have access to a number of features, such as, as non-limiting examples, “Carsoul Mate” Survey 116, which will match potential buyers with vehicles based on their answers to a series of survey questions Research, which allows potential buyers to access industry standard research data and Get the Best Deal 114, a supplied set of car buying tips for buyers.

In order to gain access to an extended set of website features, a user is required to register 130. There are two levels of registered buyers. Level one registration requires users to enter only the minimum information required to set up their buyer account. Level two registration provides options for users to enter additional information.

The fields required are username, password, password confirmation, email address and zip code, as non-limiting examples.

Users have the option of supplying additional and optional contact information, such as Name, Address and Phone Number. Additional demographic information may be collected which could be used to target marketing and advertisements within the site.

Registered users returning to the site will login to their account. By logging in, buyers will be returned to their “Personalized Shopping” page 136. A lost username/password process will exist to aid returning users who have lost or forgotten their user credentials.

A buyer will be able to maintain their user profile 164, reset their password and keep their personal data up-to-date. The buyer profile will also allow users to supply the additional information necessary to move from level one user access to level two user access. In addition, the user will have the option to supply further demographic data.

The “Get the Best Deal” page 114 will provide potential buyers with a list of general car buying tips as well as tips on using the site, such as effectively utilizing the “Let's Tango” feature 144 to engage sellers in direct competition. Through this section of the site, users will also be able to access a flash/animation walk-through of the site and its various features.

In order to better educate potential buyers and to help narrow down their vehicle selections a Research feature 120 is provided where research results 122 and research details 124 are provided. The system may integrate with an existing vendor, to offer buyers best in class automotive data. Through the system, buyers will be able to: Research new and used vehicles, Perform side-by-side comparisons and View used car values. Research data include, for example, standards, options, technical specifications and vehicle photos.

If a potential buyer is not certain of the specific vehicle they are interested in purchasing, the system offers a matchmaking service to find a vehicle that aligns with a buyer's vehicle requirements and interests. The buyer will answer a series of survey questions 116 ranging from vehicle preferences, such as type (SUV versus convertible) to personal questions related to hobbies and interests. Using a system defined algorithm, “Carsoul Mate” 116 will return a set of suggested vehicle matches 118.

If a user is logged in, they will have the option of viewing vehicle presentations 140 from system inventory for their recommended vehicles.

Non-registered users will be directed to the “Get Started” registration screen 130 in order to register and search the systems inventory for vehicles recommended by the “Carsoul Mate” 116 tool and a “put us to work” 132 search.

Demographic information collected through the “Carsoul Mate” survey tool 116 may be used for targeting advertisements to the buyer.

The system's contact information will be supplied as well as a form to collect user feedback and comments 126.

Following registration, users will be able to search the systems vehicle inventory 138 and manage their “Personalized Shopping” page 136. The “Personalized Shopping” page 136 is comprised of a number of key features, including, My Searches 138, Presentations 140, Favorites 142, “Let's Tango” 144, “Sales Rack” 146, and Messages 146.

A search tool 138 is provided to buyers to assist them in locating vehicles in their area. Buyers will be able to define search parameters such as, for example, Vehicle type, Body style, Make, Model, Dealer Preference, Include Private Party Sellers, Price, Zip code and “x” miles from zip code, Additional Vehicle Attributes (i.e. color).

The search parameter selection values filter based on related criteria, for example once a vehicle make is selected, only models associated with that make of vehicle will be available for searching. The data used to populate the search criteria will be obtained from a third party. The results of the buyer's search are displayed within the presentations section of the buyer's “Personalized Shopping” page. Buyers are able to perform an unlimited number of vehicle searches. A buyer can elect to save a search or a number of searches to the My Searches 138 section of their “Personalized Shopping” page 136. The system will continue to search for vehicles matching the criteria identified in saved searches and will add the new vehicles to the buyer's list of presentations.

New presentations will always be featured at the top of the list and indicated as new. For example, presentations created by certified sellers will appear above the presentations of non-certified sellers. In another example, the buyer is notified via email when new presentations 140 have been added to their “Personalized Shopping” page 136.

Buyers are able to modify and delete their saved searches 124. Through the seller module, sellers that subscribe to the system are able to view the searches 230 performed in their area, which allow them to tailor their presentations 218 or upload inventory 226 that is being sought.

If a buyer performs a search that does not find any matching vehicles or a very limited set, the buyer will have the option to save the search as a “Wish List” search. “Wish List” searches are flagged within the Seller module 200, so that sellers will know that a buyer is looking for a vehicle in which the system has zero or very limited inventory, providing sellers with an opportunity to fulfill an unmet buyer need.

The presentations page 140 will continue to be updated as new presentations are added 278 that match the buyer's saved search criteria. The initial view of the featured presentations will be the summary view 110. The summary will feature, for example, Vehicle year, Make, Model, Price, Mileage, Vehicle Market Value, Thumbnail image, if available and Brief description, if available.

The summary view also indicates if the vehicle presentation is being made by a certified seller. Buyers are able to sort and delete presentations 140. Buyers will also be able to move presentations to their favorites list or to the “Let's Tango” section 144. New presentations will be indicated as “new” until the buyer has viewed the presentation details. The presentation details also includes an extended vehicle profile. The level of detail will vary based on the information supplied by the seller.

Dealers have the opportunity to supply numerous photos, detailed descriptions, options, warranties and additional details by uploading presentations images 274 and adding presentations 278 or editing presentations 276.

From the presentation details 150, a buyer will be able to send a message to the seller 156. The system will supply buyers and sellers with a messaging component 156, 244. These communications allow buyers to control their interactions with the seller and maintain a level of anonymity as the only contact at this point will be through the system messaging. A buyer is also able to initiate an online chat session with a seller 158 after a sign-in 162.

The seller's profile will be accessible from the presentation details 152 as well as an inventor list 154. The seller's profile 152 contains information about the seller's dealership and contact information for both dealers and private party sellers. In addition, the seller profile 310, 316 will include buyer reviews and a system rating for the seller. If the seller subscribes to the system inventory service, a full listing of the dealer's vehicle presentations 218 will be accessible from the seller's profile. Included in the seller's profile will be a feature for a level two buyer to indicate that they would like to share their contact information with a seller. This will further qualify the lead for the seller and the buyer and the seller can engage in additional dialogue regarding a vehicle purchase. A buyer can elect to share their contact information at any point.

As the system 100 identifies presentations 218 for the buyer, the buyer will be able to move certain vehicle presentations to a favorites list 142 within their “Personalized Shopping” page 136. While the search will continue to update a buyer's presentation section 140 with new vehicles 148, buyers control the vehicles that are included as favorites. Buyers can sort their favorites, remove vehicles and move selected vehicles from favorites 142 to “Let's Tango” 144.

When a buyer has narrowed their search down to a handful of vehicles they place those vehicles into the “Let's Tango” 144 portion of their Personal Shopping Page 136 that the system provides for them. Once a vehicle is in “Let's Tango” 144 the seller of the vehicle is notified and invited to participate.

The seller's view of the “Let's Tango” 144 is known as “Buyerscape”. This view allows seller's to see their vehicle, the buyer who is interested in it 248, what other vehicles the buyer might be interested in, where else the buyer is looking 238, and what other deals the buyer is being offered 232.

Then seller's are given the ability to change and modify their presentation 276 to the buyers.

At the end of the “Let's Tango” 144, the buyer chooses which seller they would like the system 100 to distribute their lead information to.

It is the “Let's Tango” feature 144 that allows buyers to invite sellers to compete directly. Once a seller's vehicle has entered into “Tango”, the seller will have visibility of all other vehicles/sellers involved and the details of their presentations 232. The initial view of the “Tango” will aggregate certain data for each selected vehicle 238. The aggregate view will be similar to the vehicle summary, but will also include a “pitch” field, where sellers can make their virtual sales “pitch”. This free form text field allows sellers to offer additional incentives to the interested buyer. Sellers will be able to view the “pitches” of their “Tango” competitors 232. Buyers are able to drill-down to the detailed presentation for each vehicle included in the “Tango”. Only level two registered buyers will be able to access the “Let's Tango” functionality. Buyers who are interested in a specific vehicle are notified in a vehicle message list 242.

The “Let's Tango” feature 144 is visible to level one users and instructional text will direct buyers to update their buyer profile in order to move from level one to level two.

There will be a single “Tango” 144 per buyer and the buyer will be able to add a limited set of vehicles to their “Tango” 144. Buyers are able to terminate a “Tango” 144 at any time. Sellers are able to communicate with a buyer via the systems messaging component 234, 236, once they have been invited to a “Tango” through a sign-on 268. In addition to modifying their “pitch”, sellers will also be able to update their presentations in order to compete with other sellers.

A buyer will be notified via email if an update as been made to a presentation 276 within their “Tango” 144. The presentation will be marked as updated within the “Tango” section 144 of the buyer's “Personalized Shopping” page 136.

The “Sales Rack” 146 is an additional feature on the buyer's “Personalized Shopping” page 136. It acts as a virtual clearance rack for reduced-price vehicles. The “Sales Rack” 146 features vehicles in the buyer's area that sellers have selected to include at a discounted price. The initial view is of the presentation summary, with the ability for the buyer to drill-down to the presentation details. The functionality described above for presentations, also applies to vehicles included on the “Sales Rack” 146.

The system 100 offers buyers and sellers a messaging component that which allow them to communicate directly. A buyer must initially open the lines of communication, either by sending a message directly to a seller or including the seller's vehicle in a “Tango” 144. All messages are tied directly to a vehicle. A new message can be added from the detailed view of a “Tango” 144 or the presentation details 150.

Messages within the system are similar to a standard email and consist of a subject and a body. The message subject will default to the seller name and vehicle make and model. The message body is free form text.

The “Personalized Shopping” page 136 contains a section for messages, that functions similar to an inbox, buyers can sort 160, reply to 164 and delete messages. From the messages list 146, buyers are able access a vehicle's presentation details. If a vehicle thumbnail is available, it will also be displayed within the message list, to help buyers identify the vehicle to which the message is related.

An online chat capability is available to buyers 158 and sellers 234. Similar to messaging, online chat 162 needs to be initiated by the buyers. This functionality is accessible from the presentation details 150, if a seller has opted to use online chat, the system will display if a seller is signed in to chat.

The system site features a module for sellers to access and maintain their account 200. Sellers have the ability to upload their inventory 226, monitor buyer interest 230, compete with other sellers and communicate directly with interested buyers 236, 234. The Seller module 200 serves both private party 300 (or individual) sellers and dealerships. Private party sellers have access to a sub-set of the Seller module functionality. Private part seller functions have a like numerical indicator and functions to dealer seller functions with the exception of having a 300 series identifier.

A form is provided from the Seller module home page 204 to collect contact information from dealers that are interested in subscribing to the systems services. The form collects basic dealer contact information and allows the dealer to indicate in which services they are interested. Once a dealer submits information, a partial Dealer record is created with the status of “Interested”. An administrator is responsible for following up with Dealers (external to the system) in order to solidify the relationship. The administrator can then complete that Dealer record within the Administration module. This includes establishing a username and password, so the dealer can access the Seller module 200.

The features described in the following section are available to subscribing sellers. The seller will need to login to the Seller module in order to access this functionality.

The Dashboard Dealer or Private Party contains a snapshot of all recent activity related to the seller's vehicle inventory. The dashboard is the mechanism by which a seller can monitor their leads and any Tangos 144 in which they have been included. In each of the categories enumerated below, the seller will know how many belong to each buyer registration level (one or two). The buyer registration level can assist sellers in further qualifying a potential buyer lead. In addition, a seller is able to access buyer contact information from buyers that elected to share this information. The seller is then able to pursue this buyer lead through both the system and external arrangements. For each uploaded vehicle 226, a seller has access to: a number of presentations 218: the number of buyer accounts in which the vehicle presentation 230 is featured, Number of favorites 142: the number of buyers who have added the vehicle to their favorites page, Number of leads: the number of buyers who have initiated contact with the seller or have added the vehicle to their “Let's Tango” page 144, Number of buyer contacts: the number of level two buyers that have elected to share their contact information with the seller, and Number of messages: the number of messages received from interested buyers related to the vehicle 156.

The system allows users to link to the set of vehicle messages including Number of Tangos 144: the number of buyer Tangos in which the vehicle is involved. If the vehicle is included in a user's “Let's Tango” page, the seller will be able to drill-down to the “Tango” details 238 (multiple “Tangos” could exist for a single vehicle).

A seller is able to view the presentation detail for each of their vehicles from their dashboard and make any necessary presentation edits.

The “Tango” 144 allows sellers to compete for the buyer's business. From the Seller Dashboard 212, 312, the seller will be able to view a list of all Tangos 144 for which their vehicle is included. The seller will have visibility into the details of each “Tango” 144. This detailed view include all sellers and their current vehicle presentations. The seller's view mimics the buyer's view. The seller will be able to edit their virtual “Sales Pitch” and view the “Sales Pitch” information supplied by the competing sellers.

Buyers and sellers have a messaging component 156, 236, 336 that allows them to communicate directly. A buyer must initially open the lines of communication, either by sending a message directly to a seller or including the seller's vehicle in a “Tango” 144. All messages are tied directly to a vehicle. A new message can be added from the detailed view of a “Tango” or the presentation details.

Messages within the system are very similar to a standard email and consist of a subject and a body. The message subject will default to the dealer name and vehicle make and model. The message body is free form text. The seller's dashboard 212 lists the number of messages a seller has received per vehicle and provides a link to view the full list of messages. The message lists will function similar to an inbox; sellers can sort, reply to and delete messages.

The system collects additional contact information from its level two registered buyers. As a buyer's interest in a vehicle becomes more serious or their confidence in a dealer increases, they can elect to share their full profile 164 with a seller. Sellers are able to view this contact record and pursue the sale directly with the buyer through the additional contact methods.

Dealers have different options related to supplying their vehicle inventory to the system. These options are:

Upload vehicle inventory from their Inventory Management System (IMS) 258 is provided to provide new presentations 260. The system accepts a standard data feed from the IMS 258. The IMS data populates a presentation. The dealer is able to further edit and modify the presentation within the system.

If a dealer only stores VIN numbers and prices in their IMS, then the system uses data from a third party partner to decode the VIN and populate a system presentation with available vehicle data (i.e. standard options, stock photos).

All vehicles within the system are displayed via a presentation 318. The system supplies the presentation template. Inventory uploaded via an IMS will populate a presentation, but can be edited 276 through the presentation management functionality and uploaded 274. If a seller is not uploading inventory, they may add their inventory directly into a presentation 278, 378.

Each presentation contains information for display as part of the summary view as well as the additional information needed to provide the presentation details. The summary view is what will be initially displayed to buyers when searching for vehicle. This includes information such as Vehicle Make, Model, Price, Mileage, Market Value, Thumbnail image and brief description. Presentations may be searched 270 presenting results 272.

The presentation template has fields reserved for image uploads and for the upload of additional file types such as media clips and audio files. This allows dealers flexibility in the presentation of their vehicle data. To this end, only fields populated by the seller are presented to the buyer and presentations can be deleted.

An expiration date is maintained for presentations. For private party sellers and dealers that do not upload IMS data, a system setting determines the duration allowed between the current date and the expiration date. (i.e., Private party sellers can set a maximum expiration date of 2 weeks greater than the current date). Expired presentations will not be displayed to buyers.

The seller profile is accessible to buyers when viewing a vehicle presentation supplied by the dealer. This profile is the seller's opportunity to foster buyer confidence in their dealership. Sellers are able to edit and maintain this data. A seller profile 216, 316 contains information such as: General Information: Dealership Name, Contact Name, Address, Phone, Email Address, Auto Group association, Lot Information: Sales Volume, Lot Size.

Buyer comments are also included on the seller's profile as well as the Seller Rating. If the seller subscribes to the systems inventory service, then their Seller Profile 216 will also include a list of their entire vehicle inventory. Buyers will be able to view the vehicle presentation 218 for each vehicle. The seller profile 216 will provide a cancel subscription option for each option to which a seller subscribes.

“Cartango at a Glance” 222 provides sellers insight into how buyers are using the system and what vehicle searches are being performed. Sellers are able to view searches and search trends within their geographic region. All searches that are saved by buyers are tracked by the system and accessible to sellers. “Wish List” searches will be indicated, providing sellers with visibility into a potential buyer with an unmet need.

The metrics 264 provided through “Cartango at a Glance” 222 are especially important to sellers that are not maintaining a constant inventory, as they can identify desired vehicles and provide presentations to buyers as vehicles become available. Because the system is constantly polling the available inventory and updating the buyer's “Personalized Shopping” page 136, a seller needs to only add a presentation and the system will deliver it to the interested buyers. Buyers will be notified by email when new presentations are added to their presentations list 150.

The “Sales Rack” 214 is featured in a buyer's “Personalized Shopping” page 136 and is a virtual clearance rack for reduced-price vehicles. Sellers will have to subscribe to this feature in order to be granted permission to add vehicles to the “Sales Rack” 214. A seller will be able to search their current inventory of vehicle presentations and add selected clearance or reduced priced vehicles to the “Sales Rack”. The vehicle presentations will only be presented to buyers in the appropriate geographic region. All presentation management functionality will be afforded to “Sales Rack” vehicles. There will be a “Sales Rack” promotional text field included as part of the presentation template, that will allow sellers to enter a message to be displayed with the “Sales Rack” vehicle. In order to prevent misuse of this feature, administrators will set a parameter to control the number of “Sales Rack” presentations a seller can specify.

The systems contact information is supplied as well as a form to collect user feedback and comments.

Private party sellers are able to self-register for a seller account. From the external facing site, there is a Sellers link which will direct users to the Seller Module 202 and subsequent home page 312. From the home page 312 interested sellers 340 private seller registration 208 and a log-in 310 are provided. A private party (or individual) seller registration link is featured on the Seller home page. Private party sellers are required to supply the following information, as an example, First and Last Name, Address (Street, City, State and Zip Code), Phone Number, Email Address, Username, Password, Number of Vehicles, Subscription Time Period, Billing Information (Credit Card Type, Credit Card Number, CSV and Expiration Date). The system interfaces with a merchant account to verify the credit card data and charge the initial month's subscription fee.

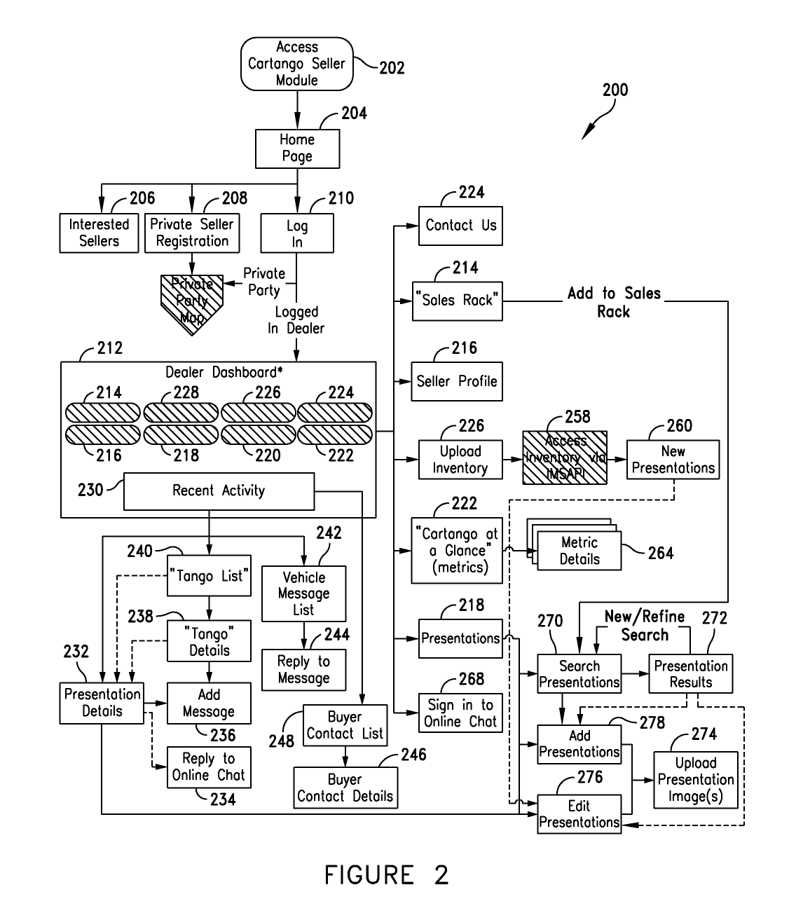

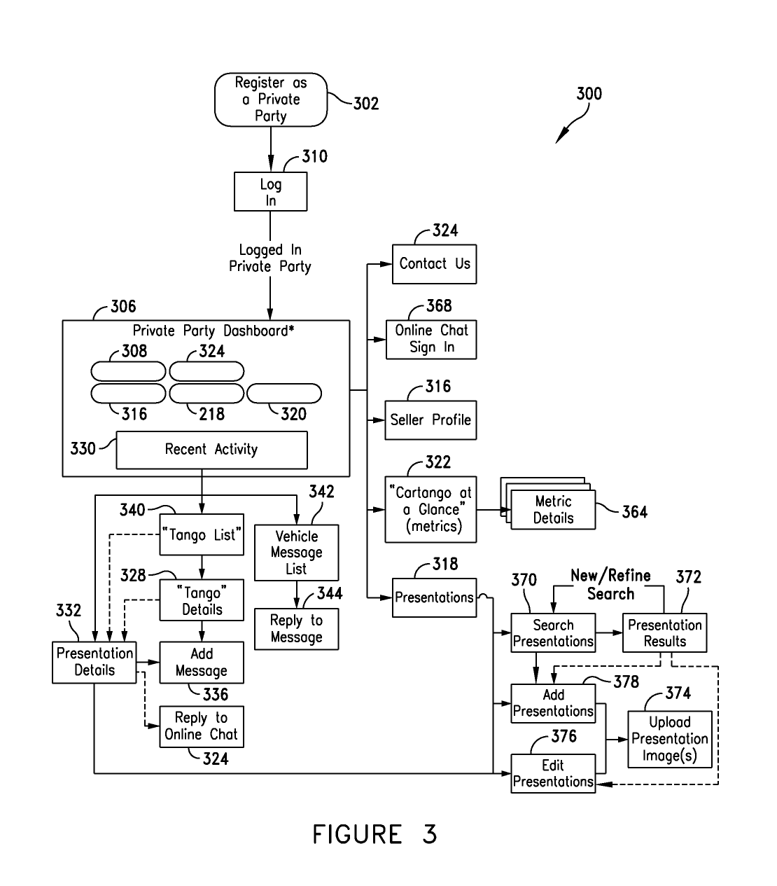

Private party sellers in FIG. 3 have access to the following seller module features as they have been defined above with FIG. 2 and therefore have similar numerical description elements. Any difference in functionality is: Seller Dashboard, Contact Us 324, Seller Profile 316: Private Party sellers will only supply general contact information.

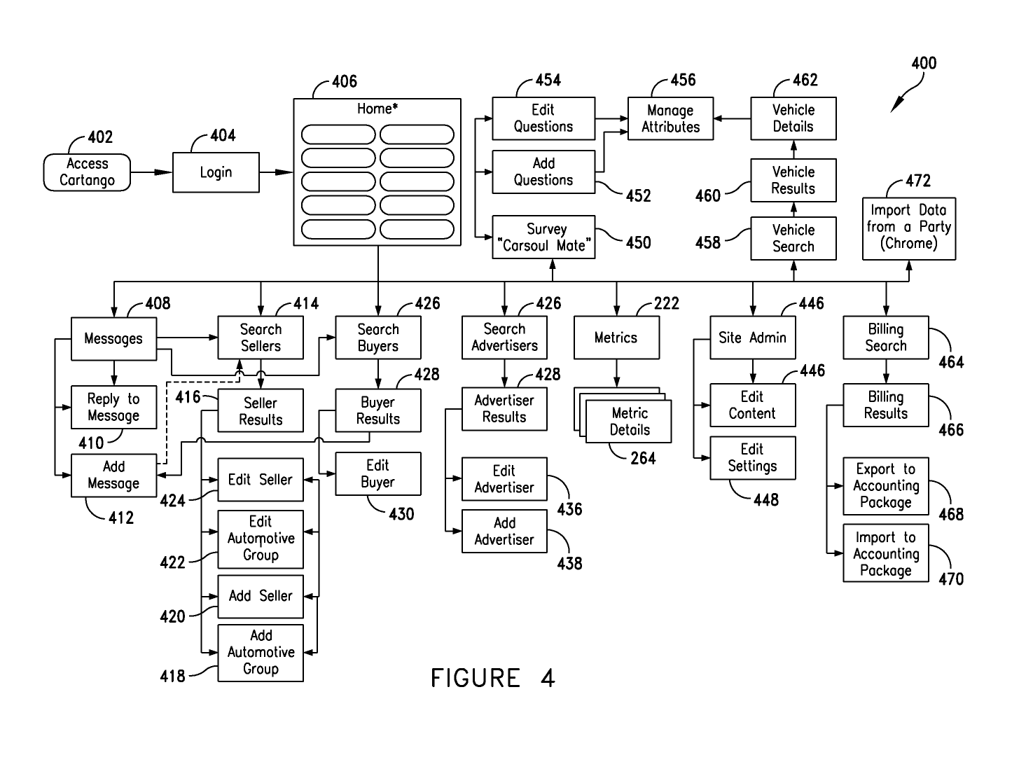

The following section defines the features that will be available to authorized system administrators and are applicable to FIG. 4. Access 402 is provided through a login 404.

System administrators 444 have the ability to set up new seller accounts 446 and manage a seller's account status and subscription plans. They also have the ability to edit settings 448. A seller can be an automotive dealership or a private party. The system offers a number of a subscription services and add on features to dealers. A dealer will select a subscription plan, which will dictate how many vehicle they may feature on the system. Monthly fees are associated with each subscription plan, for example, therefore, billing 464 and billing results 466 may be exported to an accounting purchase 468 imported 470.

In addition to subscription plans, dealers will have an opportunity to select from a set of offered add on features. There features are listed below:

Toll Free Number: The system works with third parties, to provide a virtual PBX number which will be featured as part of the seller's profile on the buyer facing site.

Basic Website: The system supplies the seller with a website template to maintain their dealership website. The template(s) and website are external to the system: Inventory Page: the system provides an additional feature as part of the seller profile, that lists the dealer's complete inventory, “Sales Rack” Postings: A “Sales Rack” feature will be included on the buyer facing the site to highlight reduced price or clearance vehicles. A dealer will need to select this feature in order to add vehicles to the “Sales Rack” section of the site.

A search mechanism 414 allows administrators to locate a specific seller and get results 416. The search criteria include information such as, for example, Type: Private Party, Dealer, Dealership Name: For Dealer type only, First Name, Last Name, Status: Active, Inactive, Interested, City, State, Zip Code.

The system returns all sellers 416 matching the user defined search criteria. From the results set, the user will have the ability to add a new seller 420 or edit an existing seller record 424, as well as edit an automotive group 422 and add an automotive group 418.

A dealer has the opportunity to express interest in subscribing to system services via the public facing system site, but only an administrator can set up and activate a new dealer account. The system creates a partial seller record, with the status set to “Interested” for those dealers that complete and submit the Interested Seller form.

The following categories of data are collected for a seller account: Account Information: Type, Status, General Information: Dealership Name, Contact Name, Address, Phone, Email Address, Auto Group association, Lot Information: Sales Volume, Lot Size, IMS Software, Billing Information: Credit Card Type, Credit Card Number, CSV Number, Expiration Date, Dealer Subscription (only for type Dealer), Subscription Type: 0 Cars, 25 Cars or Less, 26-50 Cars, 50-80 Cars, Toll Free Number: Indicates if the user will receive a specific toll free number to display as part of their seller profile, Basic Website: Indicates if the seller has purchased a website template, Inventory Page: Indicates if the seller will have a separate inventory page included as part of the seller profile, Cartango Certified: Indicates if the seller is Cartango Certified, “Sales Rack” Posting: Indicates if the seller is able to add presentations to the “Sales Rack”, Dates of Service and Dealer Rating

The system interfaces with a merchant account to verify that the credit card information provided is valid. Administrators are able to Edit Seller accounts. This includes the ability to inactivate Seller accounts and update a dealer's subscription services.

Automotive groups are used to track relationships among dealerships and for billing purposes. Administrators will indicate if a dealership is part of an automotive group and if the automotive group is the Bill To for the dealer's subscription. Administrators will be able to see all dealers associated with a given automotive group. A dealership will be limited to a single automotive group.

A search mechanism is provided to allow administrators to locate a specific buyer 426. The search criteria will include information such as, for example, First Name, Last Name, Status: Active, Inactive, Interested, Username, Email Address, Zip Code, as well as show the results 420 and the ability to edit a buyer 430.

Administrators will have the ability to search, view and edit buyer account 426 information and manage the status of a buyer account (active/inactive). Buyer profile information may include: Cartango account information: username, password, password confirmation and zip code, Contact Information: Name, Address, Phone Number, Email Address, Demographic Information: Gender, DOB, Income Level, Interests and may be edited by the system 430.

In addition to the revenue generated from dealer subscriptions, the system will generate revenue through advertisements. As the systems user population grows and more buyers share demographic information, advertisements are targeted to buyers with certain attributes. Advertisement management will be handled through the administration module. A third party tool may be selected and integrated with the system in order to support the needed advertisement functionality. Advertisers may be searched 433 and results given 434. Advertisers may be edited 436 and added 430.

Administrators will have access to a number of reports and metrics 222 that provide insight into how the system is being used by both buyers and sellers. The list below is an idea of the types of metrics that are provided to administrators, including, Number of unique visitors, Number of unique visitors that are converted to registered users, Number of Level One versus Level Two users, Referring sites, Number of accounts opened during a date range, Number of inbound calls to the system provided toll free phone numbers, History of logins per user, number of logins for an account, Total number of sellers, Total number of cars uploaded across all sellers and for each seller, Number of Tangos, Average number of vehicles included in a “Tango”, Average length of a “Tango” (from creation to termination).

The messaging component that the system will provide to buyers and sellers will also be available to administrators 408. Administrators have the ability to send messages 410 to individual buyers and sellers or to broadcast a message to a group of buyers and/or sellers. An administrator will be able to use search functionality to locate message recipients. Messages initiated by administrators will not be tied to a specific vehicle.

As is true in the Buyer and Seller modules, messages are similar to a standard email and will consist of a subject and a body. The administrator will specify the subject line and the message body will be free form text. The administration module contains a message list, which will function similar to an inbox; administrators can sort, reply to 410, add 412, and delete messages.

The “Carsoul Mate” 450 is a tool that collects buyer interests and vehicle requirements in order to recommend vehicles to potential buyers.

Administrators are also able to create 453 and edit the survey questions 454 that are presented to buyers through the configuration of the website. Administrators determine the survey question as well as the answer type. Answer types include options such as list boxes, radio buttons and checkboxes.

For each answer value, the administrator will assign attributes. Attributes will be associated with vehicles 450. Administrators will also have the option of weighting a survey question, which will give it more influence in determining the vehicle “match”.

The administrator may assign attributes to all vehicle makes and models maintained within the system. These attributes will be compared to the attributes assigned to answer values in order to determine the recommend vehicles. The administrator also has the option of indicating if the recommended vehicle return set will be filtered to exclude makes and models for which Cartango has no inventory.

Administrators have the ability to update the text featured on the Get the Best Deal page. This functionality is extended to include other content areas within the site, such as the Home page and the static text contained on the buyer's “Personalized Shopping” page.

Administrators maintain a number of site parameters that affect functionality within the website. Below are examples of site settings that are maintained.

Maximum number of cars allowed in a single “Tango”. Within the Buyer module, users will not be able to add more cars to a “Tango”, than the number specified for this setting.

Number of inactive days before a buyer account is suspended. The site will suspend a buyer's account when the number of days since login exceeds the value specified for this setting. A buyer will receive an email informing them that their account will be suspended.

Number of days before a non-IMS dealer's inventory will expire. In an effort to keep inventory up to date within the site, vehicle presentations will be set to expire after “x” number of days. The seller receives an email indicating that their vehicle presentation will expire if the expiration date is not extended. This setting will also dictate how far in the future (i.e. 14 days) the seller can set the expiration date.

Number of days before a private party seller's inventory will expire. Setting functions as is explained above, but applies to private party sellers.

An export billing process 468 feeds the website accounting system. The process exports data related to seller billing and advertiser billing. For sellers, the export includes data such as the subscribing sellers, credit card information, each selected subscription service and the elected dates of service. For advertisers, the data will include the advertiser, advertisement billing type (pay per click, cost per mil) and the number of clicks or impressions.

In order to support account management, the system imports accounting records 470. A grace period is established and accounts will be inactivated when uncollected payments extend beyond the grace period. The system imports seller and advertiser identifiers, amount paid and dates of service.

Administrators are able to search for a specific vehicle 458 and associate attributes with the vehicle 460 with accompanying vehicle details 462. Attributes are used by the “Carsoul Mate” tool when recommending vehicles to potential buyers.

An import process is also present to obtain vehicle data from a third party.

It is to be understood that the present invention is by no means limited only to the particular constructions herein disclosed and shown in the drawings, but also comprises any modifications or equivalents within the scope of the claims.

What is claimed is:

1. A method of trading automobiles, comprising:
entering a preferred set of attributes for a purchase of an automobile;
creating a personalized shopping page based on the preferred set of attributes;
searching a database of automobiles satisfying the preferred set of attributes; and
displaying automobiles from the database that satisfy the preferred set of attributes.

2. The method according to claim 1, wherein the displaying of the automobiles from the database that satisfy the preferred set of attributes, includes at least one of presenting an automobile seller profile and providing an automobile seller profile inventory list.

3. The method according to claim 1, wherein the personalized shopping page has at least one of a favorites list, a message list, a presentation of search results list, a search parameters list and a buyer profile.

4. The method according to claim 1, further comprising:
initiating the trading of automobiles by entering and verifying a user through a log-in portal.

5. The method according to claim 4, further comprising:
completing an initial registration for a user prior to the initiating the trading of the automobile by entering and verifying the user.

6. The method according to claim 1, further comprising:
providing a message list allowing a buyer and a seller of an automobile to communicate.

7. The method according to claim 6, wherein a mode of communication is email.

8. The method according to claim 1, further comprising:
listing a best deal on at least one class of automobiles prior to the creation of the personalized shopping page.

9. The method according to claim 1, further comprising:
creating the database of automobiles by obtaining inventory lists from a seller using a seller module.

10. The method according to claim 9, wherein the seller module provides at least one of providing a contact method between a buyer and a seller, providing a seller profile to at least one of a buyer and a seller database, providing a search presentation for advertising of the seller, and providing an on-line chat capability between a buyer and a seller.

11. The method according to claim 10, further comprising:
conducting a log-in for the seller module.

12. The method according to claim 10, further comprising:
providing recent activity results of searches performed by potential buyers to sellers.

13. The method according to claim 9, wherein the seller module is one of a commercial seller and a private party seller.

14. A program storage device readable by machine, tangibly embodying a program of instructions executable by machine to perform method steps to trade an automobile, comprising:
entering a preferred set of attributes for a purchase of an automobile;
creating a personalized shopping page based on the preferred set of attributes;
searching a database of automobiles satisfying the preferred set of attributes; and
displaying automobiles from the database that satisfy the preferred set of attributes.

15. The program storage device according to claim 14, wherein the displaying of the automobiles from the database that satisfy the preferred set of attributes, includes at least one of presenting an automobile seller profile and providing an automobile seller profile inventory list.

16. The program storage device according to claim 14, wherein the personalized shopping page has at least one of a favorites list, a message list, a presentation of search results list, a search parameters list and a buyer profile.

17. The program storage device according to claim 14, further comprising:
initiating the trading of automobiles by entering and verifying a user through a log-in portal.

18. The program storage device according to claim 17, further comprising:
completing an initial registration for a user prior to the initiating the trading of the automobile by entering and verifying the user.

19. The program storage device according to claim 14, further comprising:
providing a message list allowing a buyer and a seller of an automobile to communicate.

20. The program storage device according to claim 19, wherein a mode of communication is email.

21. The program storage device according to claim 14, further comprising:
listing a best deal on at least one class of automobiles prior to the creation of the personalized shopping page.

22. The program storage device according to claim 14, further comprising:
creating the database of automobiles by obtaining inventory lists from a seller using a seller module.

23. The program storage device according to claim 22, wherein the seller module provides at least one of providing a contact method between a buyer and a seller, providing a seller profile to at least one of a buyer and a seller database, providing a search presentation for advertising of the seller, and providing an on-line chat capability between a buyer and a seller.

24. The program storage device according to claim 23, further comprising:
conducting a log-in for the seller module.

25. The program storage device according to claim 23, further comprising:
providing recent activity results of searches performed by potential buyers to sellers.

26. The program storage device according to claim 22, wherein the seller module is one of a commercial seller and a private party seller.

27. The method according to claim 1, wherein in the creating the personalized shopping page based on the preferred set of attributes, at least two sellers compete in advertising of automobiles.

28. The method according to claim 1, further comprising:
completing an on-line questionnaire to determine an appropriate automobile choice for a consumer; and
displaying the automobile choice to an individual.

29. The method according to claim 1, further comprising:
searching the database of automobiles satisfying the preferred set of attributes at a defined interval; and
displaying results of the search to an individual.
